(19) United States
(12) Patent Application Publication
(10) Pub. No.: US 2006/0023453 A1
(43) Pub. Date: Feb. 2, 2006

(54) Burner assembly

(76) Inventors: John W. Lee, Sweet Home, OR (US); Jimmy Perez, Corvallis, OR (US); Andrew R. Lovvom, Albany, OR (US); David E. Huhn, Monmouth, OR (US); Robert C. Sattem, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/005,928

(22) Filed: Dec. 6, 2004

Related U.S. Application Data
(63) Continuation-in-part of application No. 10/903,536, filed on Jul. 29, 2004.

(51) Int. Cl. F21V 33/00

(52) U.S. Cl. 362/253

(57) ABSTRACT

A burner assembly includes a burner, a header coupled to the burner, a holder coupled to the header, contacts coupled to the holder, and electrical connections coupling the contacts to the burner.

### RELATED APPLICATONS

The present application is a continuation in part of commonly assigned U.S. patent application Ser. No. 10/903,536 filed Jul. 29, 2004.

### BACKGROUND

Digital projectors, such as digital mirror devices (DMD) and liquid crystal display (LCD) projectors, project high-quality images onto a viewing surface. Both DMD and LCD projectors utilize high-intensity lamp assemblies to generate the light needed for projection. Light generated by the lamp assembly is created by a burner that produces light concentrated as a “fireball,” located at a focal point of a reflector. This light is directed into a projection assembly that produces images and utilizes the generated light to form the image. The image is then projected onto a viewing surface. Misalignment of the focal point causes degradation of the image, since less light is captured, and creates “hot spots” on the screen instead of a uniform brightness.

Efforts have been directed at making projectors more compact while making the image of higher and better quality. As a result, the burners utilized have become more compact and of higher intensity. Higher intensity burners produce high, even extreme heat. The outer surface of the burners can approach temperatures of 900° C. As a result, projector designs must account for the intense heat. In addition, losses due to misalignment of the fireball with respect to the reflector are amplified in systems utilizing high-intensity burners.

Some designs attempt to account for the heat by permanently placing the burner within the reflector. The use of a high temperature “epoxy” holds the burner relative to the reflector. When the burner has surpassed its useful life, the entire lamp assembly, including the costly reflector and burner, is discarded and replaced with a new assembly.

Recent efforts have been directed to replaceably coupling the burner to the reflector. These designs frequently make use of a header that includes electrical connections and that provides alignment for the burner relative to the reflector. Metal electrical connections placed on the header may cause the electrical connections to heat as the burner heats up. The elevated temperature of the burner may increase the oxidation and/or corrosion rate of the contacts.

### SUMMARY

A burner assembly includes a burner, a header coupled to the burner, a holder coupled to the header, contacts coupled to the holder, and electrical connections coupling the contacts to the burner.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a schematic view of a display system according to one exemplary embodiment.

FIG. 2-1 illustrates a schematic view of a lamp assembly in which the burner assembly is outside of the housing according to one exemplary embodiment.

FIG. 2-2 illustrates a schematic view of a lamp assembly in which the burner assembly is coupled to the housing according to one exemplary embodiment.

FIG. 2-3 illustrates a schematic view of a lamp assembly in which the burner assembly is coupled to the housing and to the reflector according to one exemplary embodiment.

FIG. 3 illustrates a perspective view of a burner assembly according to one exemplary embodiment.

FIG. 4 illustrates a partial perspective view of a burner assembly focusing on the electrical connection inside a lamp holder according to one exemplary embodiment.

Throughout the drawings similar elements in different embodiments are designated with similar prefixes and different suffixes. Identical reference numbers designate similar, but not necessarily identical, elements.

### DETAILED DESCRIPTION

Burner assemblies, lamp assemblies, and methods of forming such are provided herein that include burners, headers, and holders. These assemblies and methods place the holder contacts at a location that is relatively remote from the burner. The separation of the burner and the holder contacts may allow for the use of a relatively simple header.

Further, such a separation may allow for the use of relatively inexpensive materials for the holder contacts due to the lower temperature associated at the offset location. In addition, the offset may provide space to use relatively simple coupling operations to couple the burner leads to the holder contacts, such as by crimping the burner leads to the flexible wires.

A general display system will first be discussed, followed by the interaction of another exemplary burner assembly associated with a display system. The exemplary burner assembly is then discussed in more detail, as well as suitable methods for forming the burner assembly.

In the following description, for purposes of explanation, numerous specific details are set forth in order to provide a thorough understanding of the present method and apparatus. It will be apparent, however, to one skilled in the art, that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Display System

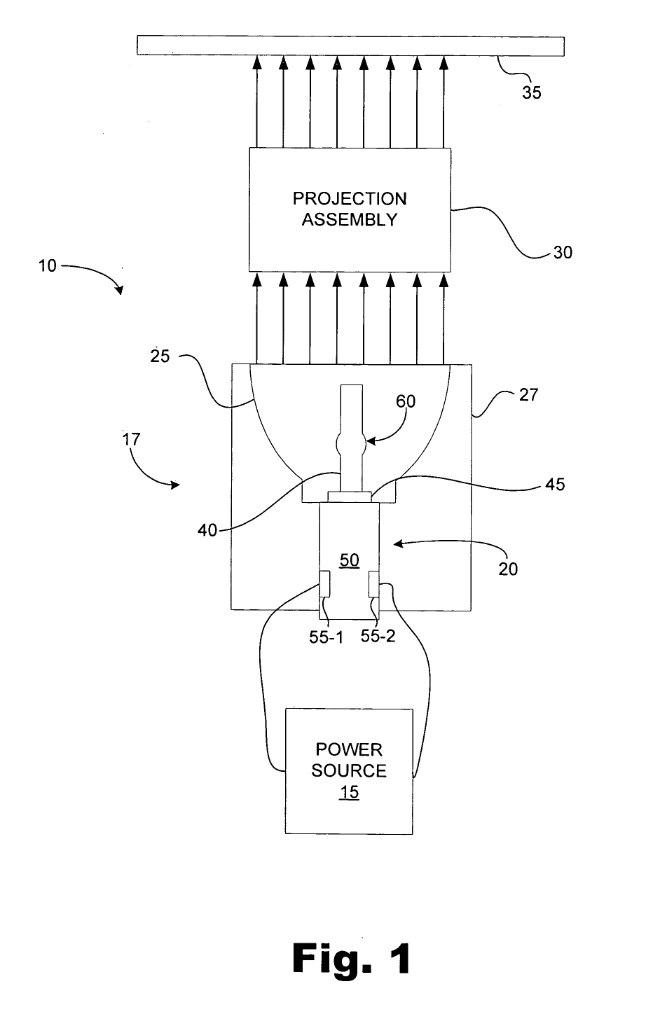

FIG. 1 is a schematic view of a display system (10). The display system (10) generally includes a power source (15), a lamp assembly (17) including a burner assembly (20) and a reflector (25) housed within a housing (27), a light modulator or projection assembly (30), and a viewing surface (35). The burner assembly (20) is configured to be removably coupled to the reflector (25) and the housing (27). The power source (15) is also coupled to the housing (27). As will be discussed in more detail below, the burner assembly (20) includes electrical contacts that are located remotely from the burner, thereby decreasing heating effects on the electrical contacts and possibly allowing for more rapid formation processes.

In particular, the burner assembly (20) includes a burner (40) coupled to a header (45). The header (45) provides support and alignment for the burner (40) relative to the reflector (25). The burner assembly (20) also includes a holder (50) coupled to the header (45). Electrodes extend from the burner (40), through the header (45) and holder (50) to holder contacts (55-1, 55-2) on the holder (50). Accordingly, the burner connections (55-1, 55-2) are located remotely from the burner (40) and the header (45).

The burner assembly (20) is configured to be replaceably coupled to the reflector (25). According to one exemplary embodiment, the housing (27) has an opening defined therein that corresponds closely to the cross sectional shape of the holder (50). The burner (40) and header (45) may thus be inserted into the opening until the holder (50) comes into contact with the opening. The holder (50) is then slid toward the reflector (25) until the header (45) comes into contact with the reflector (25).

The housing (27) includes housing contacts coupled to the power source (15). These housing contacts are located such that when the burner (40) is thus coupled to the reflector (25), the housing contacts are in contact with the holder contacts (55-1, 55-2) on the holder (50), thereby coupling the power source (15) to the burner (40). Thus, the power source (15) is able to provide power to the burner (40) when the burner assembly (20) is coupled to the housing (27).

The burner (40) generates light when it receives power from the power source (15). This light is directed by the reflector (25) to the projection assembly (30). The projection assembly (30) modulates the light to form images that are projected onto the viewing surface (35).

The burner (40) emits concentrated light from a central portion or fireball generator (60). In some embodiments, the optimal operating position of the fireball generator (60) is the focal point of the reflector (25) during operation of the burner (40). Frequently, as the burner (40) is heated from a non-operating temperature to an operating temperature, the fireball generator (60) will change positions in response to heating or gravitational effects.

Accordingly, with some embodiments, once the burner (40) is cool, the position of the fireball generator (60) is offset slightly from the focal point to account for such heating or gravitational effects during operation. The interaction of a burner assembly with a reflector and housing and the orientation of that burner will be discussed in more detail below.

Lamp Assembly

FIGS. 2-1 through 2-3 illustrate a schematic view of a lamp assembly (17-1) that includes a burner assembly (200), a housing (205), and a reflector (215). The burner assembly (200) includes a burner (210), a header (220), and a holder assembly (230). The burner (210), may be of any suitable type. Suitable burners include, without limitation, ultra-high pressure (UHP) burners. For ease of reference, a UHP burner will be described.

The burner assembly (200) is shown schematically to focus on the electrical connections contained therein. The burner (210) is coupled to the header (220), which is in turn coupled to the holder assembly (230). A first burner lead (235-1) extends from the distal end of the burner (210), through the header and into the holder assembly (230). The proximal end of the burner (210) extends through the header (220) and into the holder assembly (230). A second burner lead (235-2) extends from this proximal end of the burner (210) and into the holder assembly (230). Accordingly, the first and second burner leads (235-1, 235-2) are routed into the holder assembly (230)

More specifically, the burner leads (235-1, 235-2) are routed near first and second holder contacts (240-1, 240-2). Flexible wires (245-1, 245-2) extend from the first and second holder contacts (240-1, 240-2) to burner leads (235-1, 235-2). These flexible wires (245-1, 245-2) are coupled to the burner leads (235-1, 235-2) by crimping couplers (270). While crimping couplers (270) may be used to couple the burner leads (235-1, 235-2), any other suitable method may be used, such as spot welding, etc. The flexible wires (245-1, 245-2) may allow relative motion between the header (220) and the holder assembly (230) while reducing the possibility that the burner leads (235-1, 235-2) will be decoupled from the flexible wires (245-1, 245-2) and hence the holder contacts (240-1, 240-2).

In addition, the flexible wires (245-1, 245-2) may allow relative displacement between the holder contacts (240-1, 240-2) and each of the side portions (245-1, 245-2) as the burner assembly (200) is coupled to the housing (205) and reflector (215). The interaction between the burner assembly (200) and the housing (205) and reflector (215) will now be discussed in more detail.

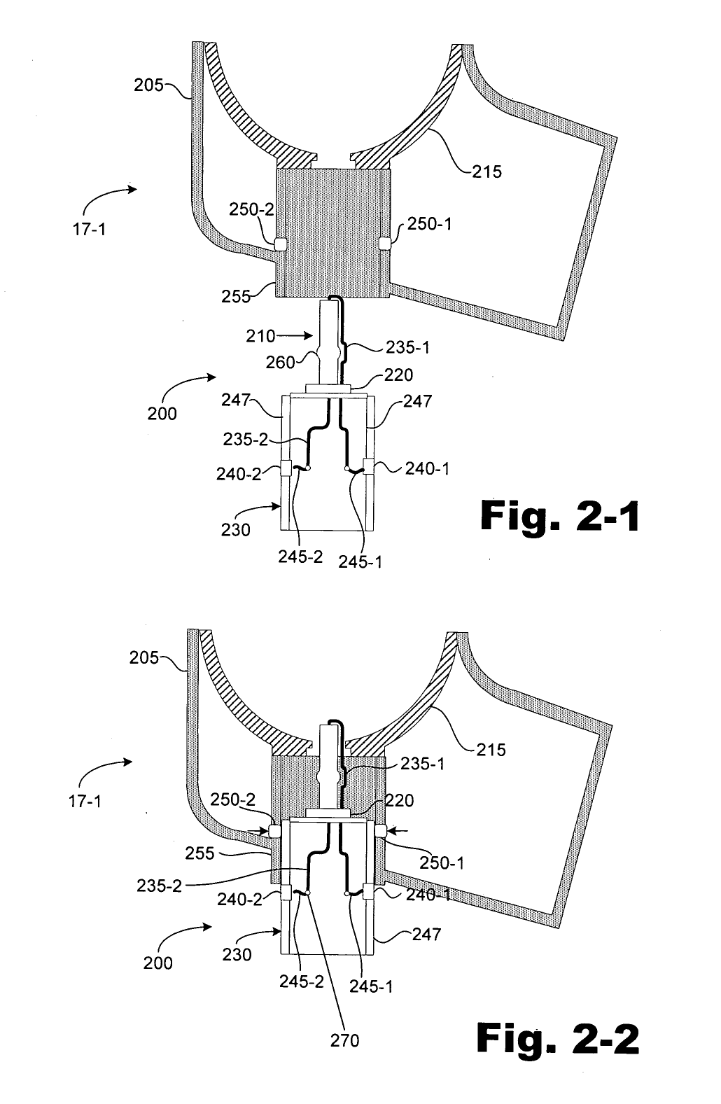

The first and second holder contacts (240-1, 240-2) according to one exemplary embodiment are located on guide rails (247). The guide rails (247) are located on opposing sides of the holder assembly (230). In FIG. 2-1, the holder contacts (240-1, 240-2) are shown in a first position in which the holder contacts (240-1, 240-2) are biased away from the center of the holder assembly (230). The holder contacts (240-1, 240-2) are configured to be coupled to housing contacts (250-1, 250-2) in the housing (205).

In particular, the housing contacts (250-1, 250-2) are located on the surface of a burner receiving portion (255) of the housing (205). The housing contacts (250-1, 250-2) are biased toward the center of the burner receiving portion (255). The burner receiving portion (255) includes an opening corresponding in size and shape to the cross section of the holder assembly (200). As a result, the holder assembly (230) is able to be placed within the lamp assembly such that the surfaces of the holder assembly (230) are in close proximity with the surfaces of the burner receiving portion.

FIG. 2-2 illustrates the burner assembly (200) being coupled to the housing (205) and reflector (215). As seen in FIG. 2-2, as the guide rails (247) come into contact with the housing contacts (250-1, 250-2), the housing contacts (250-1, 250-2) are displaced. More specifically, the housing contacts (250-1, 250-2) are pushed away from the center of the burner receiving portion (255). The displacement of the housing contacts (250-1, 250-2) causes them to exert a biasing force against the holder assembly (230), as indicated by the arrows.

As introduced, the header (220) is configured to be coupled to the reflector (215). To couple the header (220) to the reflector (215), the holder assembly (230) is advanced relative to the burner receiving portion (255) until the header (220) comes into contact with the reflector (215).

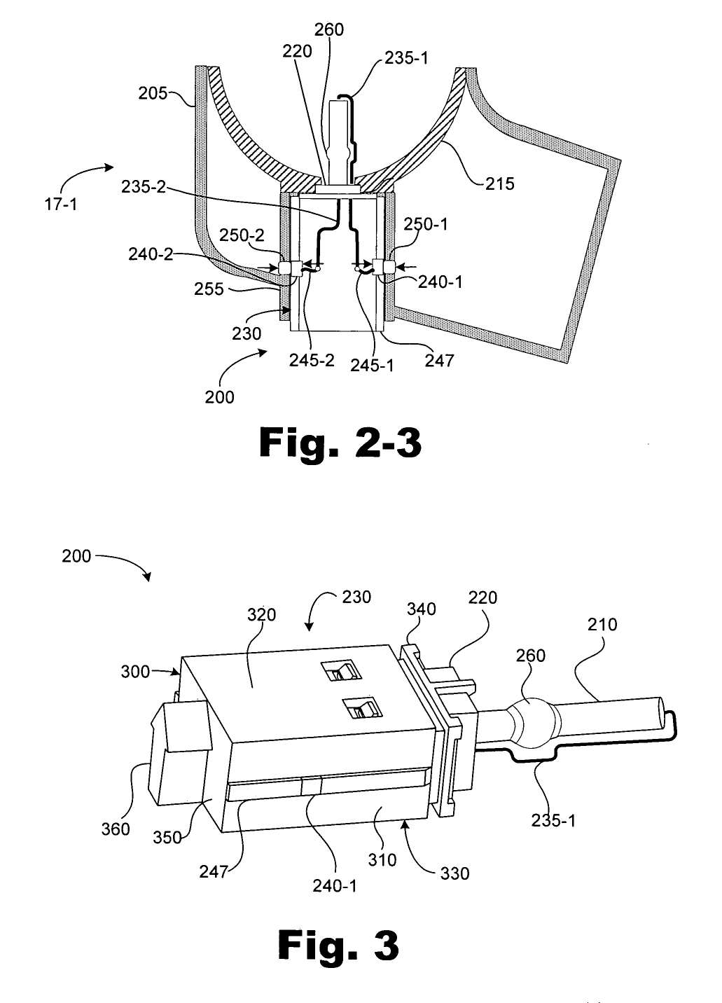

FIG. 2-3 illustrates the burner assembly (200) fully coupled to the housing (205) such that the header (220) is coupled to the reflector (215), the burner (210) is in position relative to the focal point of the reflector (215), and the holder contacts (240-1, 240-2) are coupled to the housing contacts (250-1, 250-2).

When the housing contacts (250-1, 250-2) come into physical contact with the holder contacts (240-1, 240-2), the holder contacts (240-1, 240-2) are displaced slightly in response to the biasing force applied thereto by the housing contacts (250-1, 250-2). This biasing force exerted by the housing contacts (250-1, 250-2) is balanced by a biasing force exerted by the holder contacts (240-1, 240-2) as the holder contacts (240-1, 240-2) are displaced. The opposing biasing forces, as noted by the arrows, may help ensure that the holder contacts (240-1, 240-2) remain coupled to the housing contacts (250-1, 250-2).

As previously discussed, flexible wires (245-1, 245-2) are used to couple the holder contacts (240-1, 240-2) to the burner leads (235-1, 235-2). As the holder contacts (240-1, 240-2) are displaced, the flexible wires (245-1, 245-2) flex relative to the relatively stiff burner leads (235-1, 235-2). Consequently, the flexible wires (245-1, 245-2) may decrease the possibility that the holder contacts (240-1, 240-2) will become decoupled from the burner leads (235-1, 235-2) and the burner (210).

When the burner assembly (200) is thus coupled to the housing (205), the burner (210) is able to receive power from a power source coupled to the housing contacts (250-1, 250-2). In particular, the power is directed to the burner (210) from the housing contacts (250-1, 250-2), to the holder contacts (240-1, 240-2), to the flexible wires (245-1, 245-2), to the burner leads (235-1, 235-2), and to opposing electrodes in the burner (210).

A voltage differential is thereby created at the opposing electrodes in the burner (210). This voltage differential creates a fireball in a central portion (260) of the burner. In the case of a UHP burner, the burner includes a mercury vapor or other vapor-filled tube that results in the generation of a plasma caused by an arc across the two electrodes. The reflector (215) then directs the light out of the lamp assembly (17-1).

Accordingly, the burner assembly (200) places the holder contacts at a location that is relatively remote from the burner. As previously discussed, the separation of the burner and the holder contacts may allow for the use of a relatively simple header. Further, such a separation may allow for the use of relatively inexpensive materials for the holder contacts due to the lower temperature associated at the offset location. In addition, the offset may provide space to use relatively simple coupling operations to couple the burner leads to the holder contacts, such as by crimping the burner leads to the flexible wires.

Burner Assembly

FIG. 3 illustrates the burner assembly (200) according to one exemplary embodiment in more detail. The burner assembly (200) generally includes a burner (210), a header (220) and a holder assembly (230).

The burner (210) is coupled to the header (220). In particular, the burner (210) may be aligned relative to the header (210) and secured in place using a high temperature adhesive. Thereafter, the burner leads (235-1, 235-2) may be coupled to the burner (210). The first burner lead (235-1) may then be routed through the header (220).

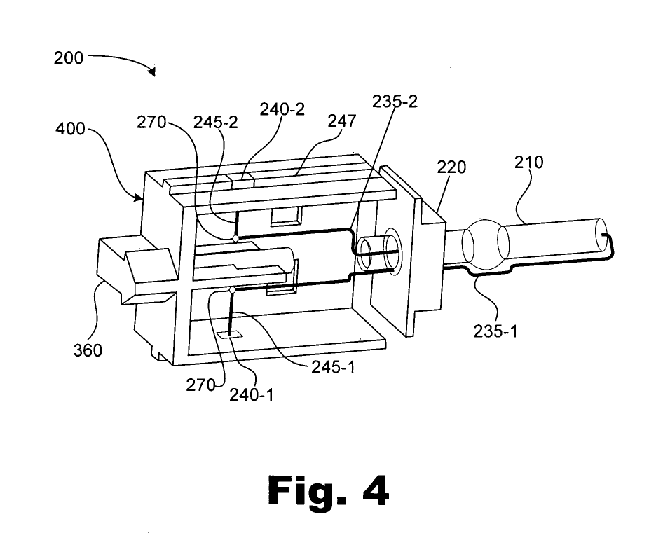

As previously discussed, the header (220) provides structural support and alignment of the burner (210). The header (220) may be made of any thermally stable material. For example, the header (220) may be made of solid ceramic material. The header (220), with the burner (210) and leads (235-1; 235-2, best seen in FIG. 4) attached, is coupled to the holder assembly (230).

In particular, the holder assembly (230) includes a generally hollow box-type structure formed by opposing side portions (300, 310), a top portion (320) a bottom portion (330), and first and second end portions (340, 350). The second end portion (340) is configured to have the header (220) coupled thereto. The opposing side portions (300, 310), the bottom portion (330) and the second end portion (340) may be formed as a base member (400), as seen in FIG. 4. Thereafter, the first end portion (330), with the header (230) coupled thereto may be coupled to the base member (400, FIG. 4). The electrical routing between the holder contacts (240-1, 240-2; FIG. 2) and the burner (210) may be then established.

Turning now to FIG. 4, previously discussed, the holder contacts (240-1; 240-2) which are coupled to the guide rails (247) on the side portions (300, 310; FIG. 3), are coupled to flexible wires (245-1, 245-2). The structure formed by the base member (400, FIG. 4) and combination of the first end portion (340), burner (210), header (220), and burner leads (235-1, 235-2) includes space between the side portions (300, 310) and the burner leads (235-1, 235-2). This space may allow for the rapid coupling of the flexible wires (245-1, 245-2) of the holder contacts (240-1, 240-2) and the burner leads (235-1, 235-2), such as by crimping, as has been discussed.

Thereafter, the top portion (320; FIG. 3) may be coupled to the assembly. The components of the base member (400) and the top portion (320) may be formed of any suitable material. Exemplary materials include, without limitation, plastic materials. The first end portion (340) may be formed of any suitable material, including, without limitation, high temperature plastic materials.

Accordingly, the configuration of the burner assembly (200) places the holder contacts (240-1, 240-2) at a location that is relatively remote from the burner (210). The separation of the burner (210) and the holder contacts (240-1, 240-2) may allow for the use of a relatively simple header (220). Further, such a separation may allow for the use of relatively inexpensive materials for the holder contacts (240-1, 240-2) due to the lower temperature associated at the offset location. In addition, the offset may provide space to use relatively simple coupling operations to couple the burner leads (235-1, 235-2) to the holder contacts (240-1, 240-2), such as by crimping the burner leads (235-1, 235-2) to the flexible wires (245-1, 245-2).

In addition, the holder assembly (200) may provide an indication of the proper orientation thereof. In particular, the second end portion (350) has an indicator (360) formed thereon. According to the illustrated exemplary embodiment, the indicator (360), points in a generally upward direction when the burner assembly (200) is properly coupled to a reflector.

In some embodiments, the optimal operating position of the central portion (260; FIG. 2-3) of the burner (210) is the focal point of the reflector (215; FIG. 2-3) during operation of the lamp assembly (17-1; FIG. 2-3). Frequently, as the burner (210) is heated from a non-operating temperature to an operating temperature, the central portion (260; FIG. 2-3) will change positions in response to heating or gravitational effects. Accordingly, with some embodiments, once the burner (200; FIG. 2-1) is cool, the position of the fireball generator (60, FIG. 1) is offset slightly from the focal point to account for such heating or gravitational effects during operation.

The indicator (360) helps a user maintain the burner assembly (200) properly oriented, regardless of the mounting configuration of the reflector (215). One exemplary mounting configuration for the display system (10; FIG. 1) is on a table. In this configuration, the reflector (215) is in a first orientation. As previously discussed, the heat generated by the burner (210) is extreme. When the central portion (260; FIG. 2-3) elevates due to the heat, it elevates to its optimal position with respect to the reflector (215; FIG. 2-3).

However, when the display system (10; FIG. 1) is inverted, as would be the case if the projector system is mounted to an overhead support such as a ceiling, the reflector (215; FIG. 2-3) is inverted from the first orientation to a second orientation. As a result, in order to maintain the central portion (260; FIG. 2-3) in the optimal position with respect to the reflector (215; FIG. 2-3), after the central portion (260; FIG. 2-3) elevates as a result of heating, it would be necessary to rotate the burner assembly (200; FIG. 2-3) 180 degrees with respect to the reflector (215; FIG. 2-3) to a second orientation.

The indicator (360) indicates to the proper orientation of the burner assembly (200; FIG. 2-3). For example, when the burner assembly (200) is properly oriented, the indicator (360) will point in a generally upward direction.

In conclusion, burner assemblies, lamp assemblies, and methods are provided here that places the electrical contacts of the burner assemblies at a location that is relatively remote from the burner. As previously discussed, the separation of the burner and the holder contacts may allow for the use of a relatively simple header. Further, such a separation may allow for the use of relatively inexpensive materials for the holder contacts due to the lower temperature associated at the offset location. In addition, the offset may provide space to use relatively simple coupling operations to couple the burner leads to the holder contacts, such as by crimping the burner leads to the flexible wires.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the invention be defined by the following claims.

What is claimed is:

1. A burner assembly, comprising:
a burner;
a header coupled to said burner;
a holder coupled to said header,
contacts coupled to said holder; and
electrical connections coupling said contacts to said burner.

2. The assembly of claim 1, wherein said burner comprises an ultra-high pressure lamp.

3. The assembly of claim 1, wherein said header comprises a solid ceramic material.

4. The assembly of claim 1, wherein said holder comprises a generally box type structure.

5. The assembly of claim 4, wherein said holder comprises guide rails formed on opposing sides of said box type structure.

6. The assembly of claim 5, wherein said contacts are coupled to each of said guide rails.

7. The assembly of claim 6, wherein said electrical connections comprise flexible wires coupled to said contacts and burner leads coupled to said burner and to said flexible wires.

8. The assembly of claim 7, and further comprising a crimping coupler coupling each of said flexible wires to said burner leads.

9. The assembly of claim 7, wherein said burner leads comprise stiff wires.

10. The assembly of claim 1, and further comprising an indicator indicating the proper orientation of said burner assembly relative to a reflector.

11. The assembly of claim 1, wherein said burner assembly is configured to be replaceably coupled to a reflector and housing.

12. A lamp assembly, comprising:
a burner assembly having a burner, a header, and a holder, said burner being coupled to contacts coupled to said header at a location remote from said burner;
a housing configured to have said holder coupled thereto; and
a reflector coupled to said housing and configured to have header coupled thereto.

13. The assembly of claim 12, wherein said contacts are located on opposing sides of said holder.

14. The assembly of claim 12, wherein said burner assembly is configured to be replaceably coupled to said header and reflector.

15. The assembly of claim 12, wherein said burner is configured to be located at a focal point of said reflector when said burner is coupled to said reflector.

16. The assembly of claim 12, wherein said housing includes a burner receiving portion having electrical contacts coupled thereto, said electrical contacts on said burner receiving portion configured to be biasingly coupled to said electrical contacts on said holder.

17. The assembly of claim 16, and further comprising flexible wires coupled to said electrical contacts on said holder and burner leads coupled to said burner and said flexible wires.

18. A display system, comprising:
a lamp assembly a burner assembly having a burner, a header, and a holder, said burner being coupled to contacts coupled to said header at a location remote from said burner; a housing configured to have said holder coupled thereto, and a reflector coupled to said housing and configured to have header coupled thereto; and
a light modulator optically coupled to said lamp assembly.

19. A method of forming a burner assembly, comprising:
forming a holder;
coupling electrical contacts to said holder;
coupling a burner to a header;
coupling said header to said holder; and
coupling said electrical contacts to said burner.

20. The method of claim 19, wherein forming said holder includes forming a generally box type structure.

21. The method of claim 19, wherein coupling said electrical contacts to said burner includes coupling said electrical contacts to flexible wires and coupling said flexible wires to burner leads.

22. The method of claim 21, wherein coupling said flexible wires to said burner leads comprises crimping said flexible wires to said burner leads.

23. The method of claim 19, wherein coupling said electrical contacts to said holder comprises coupling said electrical contact to opposing side portions of said holder.

24. A lamp assembly, comprising:
light generating means for generating light;
holder means for holding said light generating means; and
electrical connection means for coupling said light generating means to a power source, wherein said electrical connection means are remote from said light generating means.

25. The assembly of claim 24, and further comprising indicating means for indicating the proper orientation of said lamp assembly relative to a reflector.
